(19) United States
(12) Patent Application Publication
(10) Pub. No.: US 2024/0102934 A1
(43) Pub. Date: Mar. 28, 2024

(54) Test Strip Carrier, System and Method for Test Strip Detection

(71) Applicant: National Cheng Kung University, TAINAN CITY (TW)

(72) Inventors: Yu-Cheng Lin, Tainan City (TW); Wei-Chien Weng, Chiayi County (TW); Yi-Hsuan Chen, Nantou County (TW)

(73) Assignee: National Cheng Kung University, TAINAN CITY (TW)

(21) Appl. No.: 17/985,909

(22) Filed: Nov. 14, 2022

(30) Foreign Application Priority Data
Sep. 22, 2022 (TW) 111135895

(51) Int. Cl. G01N 21/77; G01N 21/27; G01N 21/84; G06T 7/90

(52) U.S. Cl. CPC G01N 21/77; G01N 21/274; G01N 21/8483; G06T 7/90; G01N 2021/7759; G01N 2021/8488

(57) ABSTRACT

A test strip detecting system includes a test strip, a test strip detecting carrier and a mobile communication apparatus. The test strip detecting carrier includes a container structure, positioning markers and colorimetric calibrating blocks, and the colorimetric calibrating blocks are embedded inside the positioning markers. The test strip is placed in the container structure and reacts with a specimen to generate color blocks. The mobile communication apparatus controls an image capture unit to capture an original image of the test strip placed in the test strip detecting carrier; detects the positioning markers in the original image to obtain a plurality of coordinates of the positioning markers; performs image coordinate calibration according to the plurality of coordinates to generate a calibrated image; and performs a colorimetric calibration for the color blocks and the colorimetric calibrating blocks according to the calibrated image so as to generate a test result.

### BACKGROUND OF THE INVENTION

### 1. Field of the Invention

The present invention relates to a test strip detecting carrier, a test strip detecting system and a test strip detecting method, and more particularly, to a test strip detecting carrier, a test strip detecting system and a test strip detecting method for quickly performing image positioning correction and colorimetric calibration through a mobile communication device.

### 2. Description of the Prior Art

With the development of medical testing technology, many applications of rapid diagnostic test strips have been developed accordingly, such as urine test strips, influenza test strips and COVID-19 test strips, in order to help users to quickly conduct diagnostic tests and obtain preliminary disease screening results. A common detection method is to contact the corresponding test strip with the specimen to be tested, and then compare the color displayed by the test strip with the color scale on the colorimetric plate to determine the test result.

The early technology relies on human eyes to compare the color displayed on the test strip with the color scale on the colorimetric plate. However, the manual comparison process is prone to the problem of interpretation errors in colorimetry. In order for accuracy and objectivity, the industry has developed a method of applying computer vision instead of human eyes to interpret test results. In the method, the user needs to capture an image including the colorimetric plate and the test strip, and interpret the test result through image recognition. However, in this process, the detecting accuracy is often affected by image interpretation errors caused by factors such as tilt of the shooting angle, shaking or uneven light reception. Therefore, in the prior art, complicated positioning and coordinate correction procedures are applied to the captured image, and the relevant information of the colorimetric plate and the test strip are obtained respectively to perform the color level comparison for image interpretation. In this situation, a huge amount of computation and time spend is required to obtain accurate detection results. In addition, the prior art uses specific devices to fix the test strip or image capture device to limit the light source or shooting angle so as to obtain an image with better quality or to save the time required for positioning and calibration, which takes additional devices and increases additional costs for inspection. Therefore, there is a need for improvement over the prior art.

### SUMMARY OF THE INVENTION

Therefore, the present invention is to provide a test strip detecting carrier, a test strip detecting system and a test strip detecting method that use a mobile communication device to detect a test strip, which may quickly perform image positioning correction, colorimetric calibration to obtain detecting results, thereby improving the shortcomings of the prior art.

An embodiment of the present invention discloses a test strip detecting carrier for a test strip detecting system, comprising a container structure, used for containing a test strip; at least two positioning markers, formed at two sides of the container structure; and a plurality of colorimetric calibrating blocks, embedded inside the at least two positioning markers; wherein the test strip reacts with a specimen to generate at least one color block.

An embodiment of the present invention discloses a test strip detecting system, comprising a test strip detecting carrier and a mobile communication device. The test strip detecting carrier comprises a container structure, at least two positioning markers and a plurality of colorimetric calibrating blocks, wherein the container structure is used for containing a test strip, the test strip reacts with a specimen to generate at least one color block, the at least two positioning markers are formed at two sides of the container structure, and the plurality of colorimetric calibrating blocks are embedded inside the at least two positioning marker. The mobile communication device comprises an image capturing unit; a processing unit, configured to execute a program code; and a storage unit, coupled to the processing unit to store the program code, wherein the program code is configured to instruct the processing unit to execute a test strip detecting method. The test strip detecting method comprises controlling the image capturing unit to capture an original image of the test strip placed in the test strip detecting carrier, and to store the original image in the storage unit; detecting the at least two positioning markers in the original image to obtain a plurality of coordinates of the at least two positioning markers; performing image coordinate calibration according to the plurality of coordinates to generate a calibrated image; and performing colorimetric calibration for the color blocks and the plurality of colorimetric calibrating blocks according to the calibrated image so as to generate a test result.

An embodiment of the present invention discloses a test strip detecting method for a test strip detecting system, wherein a test strip detecting carrier of the test strip detecting system comprises a container structure, at least two positioning markers and a plurality of colorimetric calibrating blocks, wherein the container structure is used for containing a test strip, the test strip reacts with a specimen to generate at least one color block, the at least two positioning markers are formed at two sides of the container structure, and the plurality of colorimetric calibrating blocks are embedded inside the at least two positioning marker. The test strip detecting method comprises controlling the image capturing unit to capture an original image of the test strip placed in the test strip detecting carrier, and to store the original image in the storage unit; detecting the at least two positioning markers in the original image to obtain a plurality of coordinates of the at least two positioning markers; performing image coordinate calibration according to the plurality of coordinates to generate a calibrated image; and performing colorimetric calibration for the color blocks and the plurality of colorimetric calibrating blocks according to the calibrated image so as to generate a test result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a test strip detecting system according to an embodiment of the present invention.

FIG. 2A and FIG. 2B are schematic diagrams of placing a test strip into a test strip detecting carrier according to an embodiment of the present invention.

FIG. 3 is a schematic diagram of a process for test strip detecting method according to an embodiment of the present invention.

FIG. 4 is a schematic diagram of a plurality of positioning marker according to an embodiment of the present invention.

FIG. 5 is a color list of a plurality of colorimetric calibrating blocks according to an embodiment of the present invention.

FIG. 6 is a schematic diagram of a process for performing colorimetric calibration to generate test results according to an embodiment of the present invention.

FIG. 7 is a schematic diagram of performing edge detection to detect the control line and test line according to an embodiment of the present invention.

FIG. 8 is a schematic diagram of a test strip detecting carrier according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”.

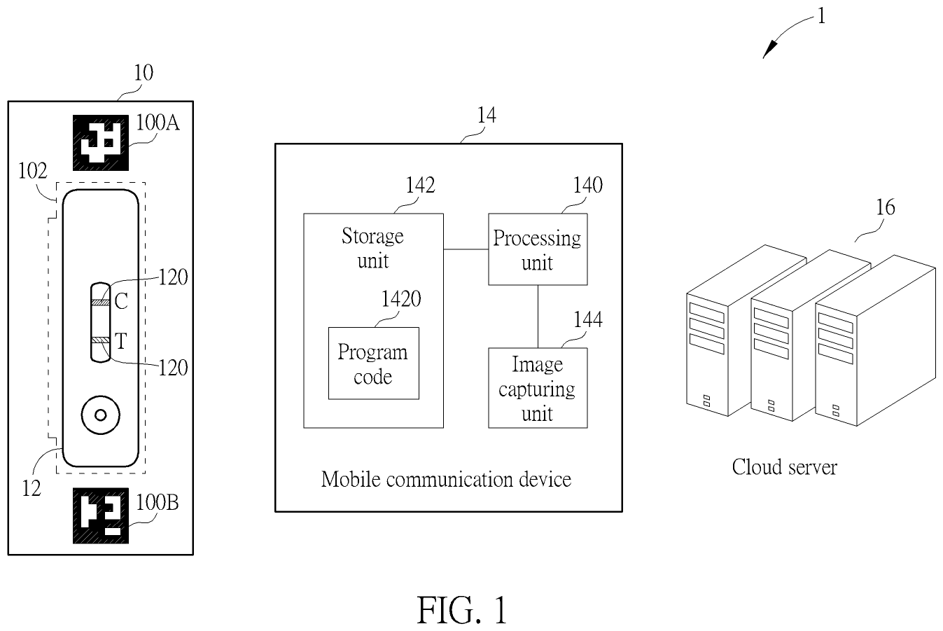

Please refer to FIG. 1, which is a schematic diagram of a test strip detecting system 1 according to an embodiment of the present invention. The test strip detecting system 1 comprises a test strip detecting carrier 10, a mobile communication device 14 and a cloud server 16. The test strip detecting system 1 uses an image recognition method to test a test strip 12, which may quickly perform image positioning, correction, and colorimetric calibration to obtain a test result. With the test strip detecting system 1, a user may place the test strip 12 on the test strip detecting carrier 10, and capture an original image including the test strip detecting carrier 10 and the test strip 12 through the mobile communication device 14 so as to obtain a test result according to a test strip detecting method and upload the original image and the test result to the cloud server 16 through the Internet. In addition, the test strip detecting method may also be executed to generate the test result by the cloud server 16 through cloud computing.

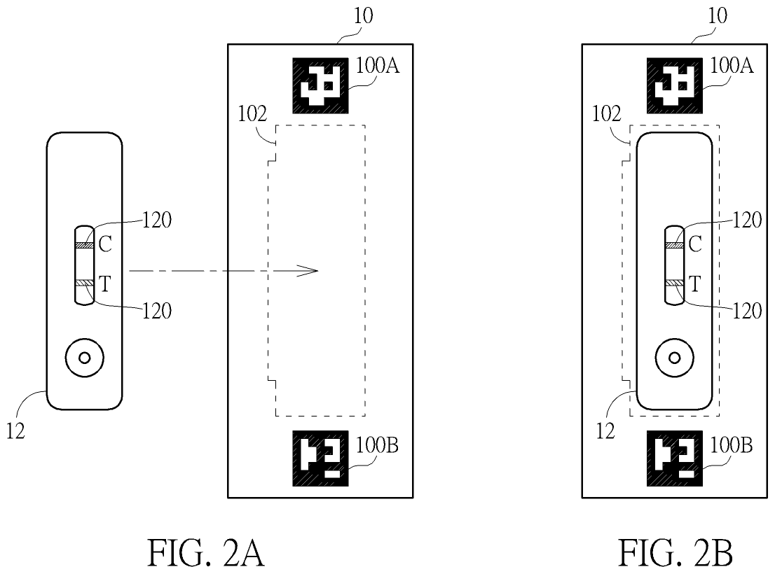

Specifically, as shown in FIG. 1, the test strip detecting carrier 10 comprises an container structure 102 (represented by dotted lines), positioning markers 100A, 100B and a plurality of colorimetric calibration blocks (not shown in the figure). The container structure 102 is used for containing the test strip 12, and the positioning marker 100A and the positioning marker 100B are respectively formed on both sides of the container structure 102. The plurality of colorimetric calibration blocks are embedded inside the positioning marker 100A and the positioning marker 100B. When a specimen is to be tested on the test strip 12, the user places the test strip 12 into the container structure 102 of the test strip detecting carrier 10 as shown in FIG. 2A and FIG. 2B. After the test strip 12 reacts with the specimen, at least one color block 120 may be generated. It should be noted that the number of the color blocks 120 shown in FIG. 1, FIG. 2A or FIG. 2B is 2, which is not limited thereto. The form and amount of the color blocks 120 may be varied according to different strip detections. In an embodiment, the test strip 12 may be a test strip using lateral flow immunochromatography assays, such as fecal occult blood test, COVID-19 rapid antigen tests, and the like. The color block 120 of the test strip for lateral flow immunochromatography assays comprises a control line (C-line, marked as “C” in FIG. 1, FIG. 2A, and FIG. 2B) and a test line (T-line, marked as “T”). The C-line is used to identify whether the test result is valid or not, and the T-line is used to present the test result. When the test result is negative, the test strip 12 will show the color blocks 120 composed of only the C-line; when the test result is positive, the test strip 12 will show the color blocks 120 composed of both the C-line and the T-line. Furthermore, when the test result is positive, the T-line will show different shades of color depending on the concentration of the specimen (such as virus, fecal occult blood, etc.).

The mobile communication device 14 may be a smart phone, comprising a processing unit 140, a storage unit 142 and an image capturing unit 144. The image capturing unit 144 may be a front camera or a rear camera of the smart phone, and is used to capture the original image including the color blocks 120 of the test strip 12, the positioning marker 100A, the positioning marker 100B and the colorimetric calibration blocks. The processing unit 140 may be a microprocessor, and generates a test result from the original image captured by the image capturing unit 144 through programs such as positioning, coordinate correction, and colorimetric calibration. The storage unit 142 may be any data storage device for storing the original image captured by the image capturing unit 144 and a program code 1420, and the program code 1420 is read and executed by the processing unit 140. In an embodiment, the mobile communication device 14 may upload the original image captured by the image capturing unit 144, and the detecting result to the cloud server 16; in another embodiment, the mobile communication device 14 may only upload the original image captured by the image capturing unit 144 to the cloud server 16 and obtain the detecting result through cloud computing. The cloud server 16 may comprise a cloud database for storing test data and historical records such as test images and test results. By cooperating with medical institutions, the test data may be incorporated into medical records as a basis for diagnosis and treatment.

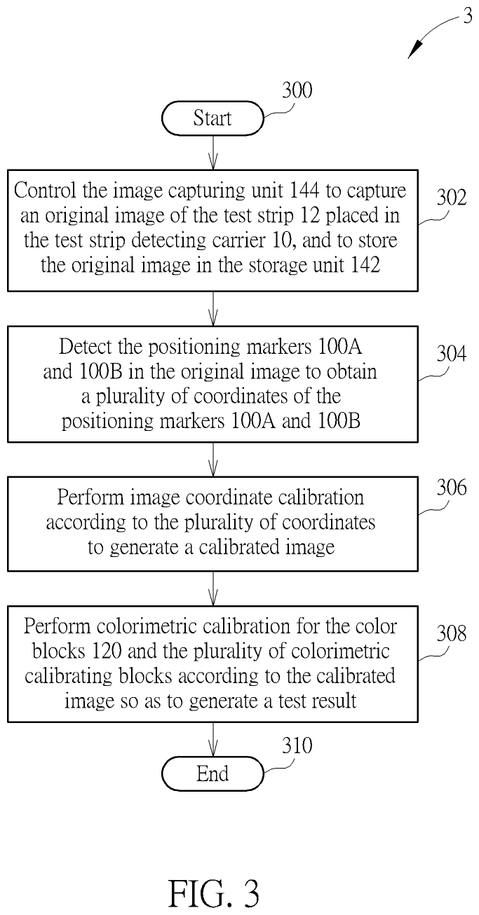

The test strip detecting method according to the embodiment of the present invention may be summarized into a process 3, as shown in FIG. 3. The process 3 is used in the test strip detecting system 1 shown in FIG. 1, and the image interpretation of the test strip 12 is performed by means of image recognition so as to generate the test result. The process 3 may be compiled as the program code 1420 and comprises the following steps:

Step 300: Start.

Step 302: Control the image capturing unit 144 to capture an original image of the test strip 12 placed in the test strip detecting carrier 10, and to store the original image in the storage unit 142.

Step 304: Detect the positioning markers 100A and 100B in the original image to obtain a plurality of coordinates of the positioning markers 100A and 100B.

Step 306: Perform image coordinate calibration according to the plurality of coordinates to generate a calibrated image.

Step 308: Perform colorimetric calibration for the color blocks 120 and the plurality of colorimetric calibrating blocks according to the calibrated image so as to generate a test result. Step 310: End.

In the process 3, after placing the test strip 12 in the test strip detecting carrier 10, the user captures an original image including the test strip detecting carrier 10 and the test strip 12 through the mobile communication device 14, and then the original image is stored in the storage processing unit 142 (Step 302). The mobile communication device 14 detects the positioning markers 100A and 100B in the original image so as to obtain a plurality of coordinates of the two positioning markers (Step 304). After obtaining the plurality of coordinates, the image coordinate correction may be performed accordingly to obtain a calibrated image (Step 306). Finally, according to the calibrated image, the colorimetric calibration between the color blocks 120 and the plurality of colorimetric calibrating blocks may be performed to generate a test result. It should be noted that, the plurality of colorimetric calibrating blocks are embedded inside the positioning marker 100A and the positioning marker 100B, and therefore when the positioning markers 100A and 100B are detected, the relevant information of the plurality of colorimetric calibrating blocks is also obtained. No additional detection and positioning of the plurality of colorimetric calibrating blocks are performed. Accordingly, the time spent for testing the test strip may be shortened to improve the shortcomings of the conventional technology.

In detail, in Step 302, the user captures the original image including the test strip detecting carrier 10 and the test strip 12 through the mobile communication device 14 and stores the original image in the storage unit 142. In Step 304, the mobile communication device 14 detects the positioning markers 100A and 100B in the original image to obtain a plurality of coordinates of the two positioning markers. In the case that the positioning markers 100A and 100B cannot be detected, the mobile communication device 14 may prompt the user to perform Step 302 again through an output unit, such as a screen or a speaker, to obtain an available original image.

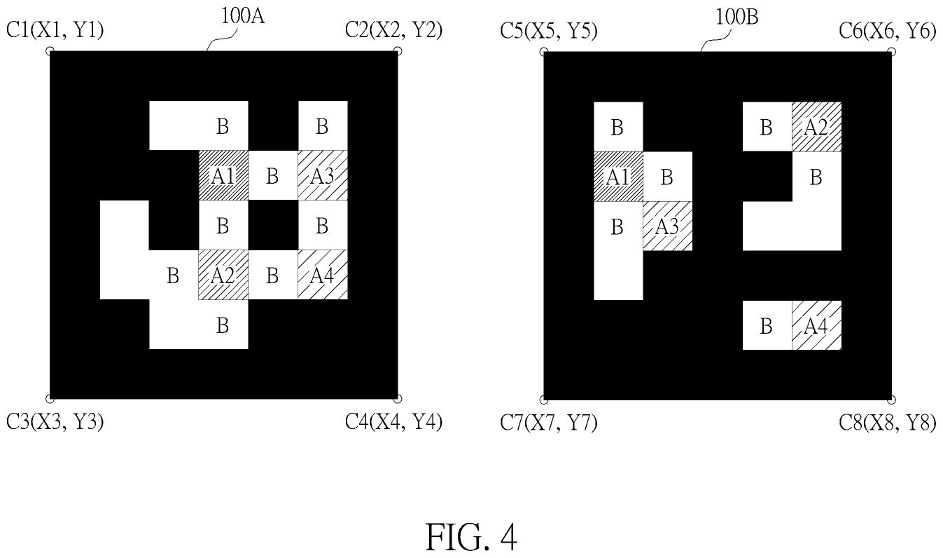

Please refer to FIG. 4, which is a schematic diagram of the positioning markers 100A and 100B according to an embodiment of the present invention. In the embodiment, the positioning markers 100A and 100B are ArUco markers. ArUco marker is a square marker with a black background, including a wide black border and an inner binary matrix composed of black and white. The black border facilitates quick detection of the marker, while the binary matrix is used to determine an identifier (ID) of the ArUco marker. The binary matrix of the ArUco marker has a special arrangement; therefore, even if the ArUco marker is rotated and then shot, it can still be detected correctly, which greatly improves the accuracy of marker detection. There are various sizes of ArUco markers, and the ArUco markers with IDs 6 and 10 in a 5×5-bit dictionary are used in the embodiment of the present invention, but not limited thereto. According to the number of colorimetric calibrating blocks required for the test item and the image output quality of the markers, those skilled in the art may adopt different ArUco markers with the number of bits that meet the actual requirements to implement the present invention. For example, in the case that the test item requires more colorimetric calibrating blocks, the ArUco mark with a larger number of bits, such as 6×6 or 7×7, may be adopted. After the ArUco mark is detected, the detected ArUco ID should be checked first. Only if the ArUco ID is 6 or 10 used in the embodiment of the present invention will the subsequent image recognition procedure be performed. If the detected ArUco ID does not match the ArUco marker used, the plurality of colorimetric calibrating blocks embedded inside the ArUco marker are not able to be obtained correctly, which leads to that the process 3 should be stopped and prompt the user to capture the available image through the output unit.

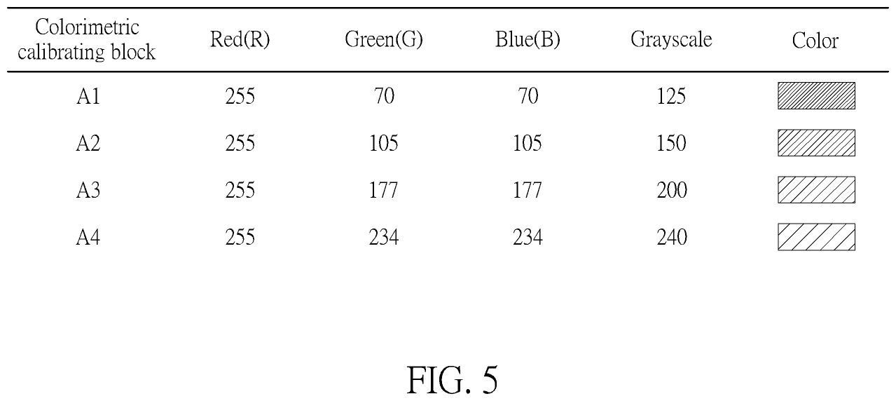

In an embodiment, the positioning markers 100A and 100B include embedded colorimetric calibrating blocks A1-A4 that respectively replace the position of a white color block in the inner binary matrix of the ArUco marker and are used for colorimetric calibration with the color blocks 120. A plurality of white color blocks B adjacent to the colorimetric calibrating blocks A1-A4 are used as reference background values for correcting the chromatic deviation caused by the ambient light source. While designing the positioning marks, the colorimetric calibrating blocks A1-A4 should be separated from each other and adjacent to the white color blocks B, so that the contrast is obvious so as to be beneficial to the discrimination and improve the accuracy. In an embodiment, the colors used for the colorimetric calibrating blocks A1-A4 are shown in FIG. 5. The colors used correspond to the colors of the color blocks 120 after the test strip 12 reacts with the specimen, and different shades of the colors reflect the different concentrations of the specimen. Note that, the colorimetric calibrating blocks A1-A4 used in the embodiment of the present invention are suitable for most of the test strips for lateral fluid immunochromatography assays on the market. However, the color blocks of different test strips and test items may show different colors after reacting with the specimen, and those skilled in the art may adjust the colorimetric calibrating blocks according to the actual detection item. Furthermore, the embodiment of the present invention adopts the ArUco markers as the positioning markers, but it is not limited thereto. The positioning markers that may be combined with the colorimetric calibrating blocks are all applicable to the present invention.

In Step 304, after detecting the positioning markers 100A and 100B in the original image, the mobile communication device 14 may obtain a plurality of coordinates of the two positioning markers. The plurality of coordinates may be coordinates C1-C8 corresponding to the four vertices of the positioning markers 100A and 100B respectively as shown in FIG. 4. It should be noted that, in the embodiment of the present invention, because the colorimetric calibrating blocks A1-A4 are embedded inside the positioning markers 100A and 100B, after obtaining the coordinates C1-C8, the colorimetric calibrating blocks A1-A4 as well as the plurality of white color blocks B as reference background may be obtained without additional detection and positioning procedures. In this step, in addition to obtaining the positions of the colorimetric calibrating blocks A1-A4 and the plurality of white color blocks B as reference background values, the color data may also be obtained. According to the color data of the plurality of white color blocks B, the chromatic deviation caused by the ambient light source may be corrected; according to the color data of the colorimetric calibrating blocks A1-A4, the subsequent colorimetric calibration may be performed to interpret the test result.

After obtaining the coordinates C1-C8 in Step 304, image coordinate correction may be performed to obtain a calibrated image according to the coordinates C1-C8 in Step 306. In an embodiment, perspective transformation may be adopted to perform image coordinate correction. The purpose of the perspective transformation is to suppress image distortion, which may avoid misjudging the test results of specimen due to the skewed angle of image acquisition by the user. In this step, a range including at least the color blocks 120 is selected as a region of interest (ROI), thereby eliminating unnecessary environmental interference. Through perspective transformation, the obtained ROI may be in a square and vertical state.

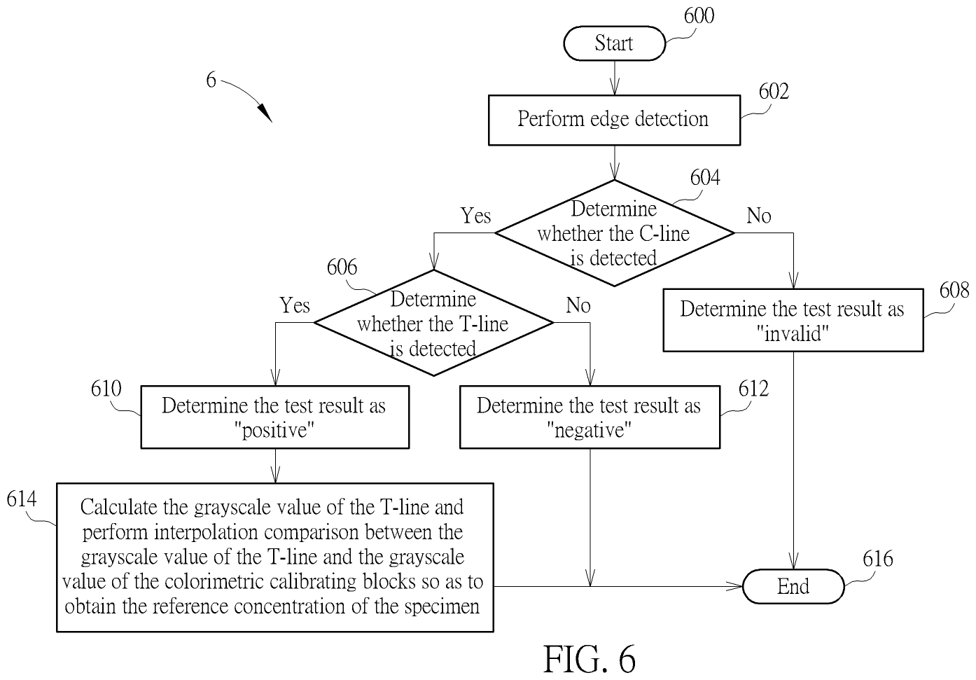

In Step 308, according to the calibrated image obtained in Step 306 and the color data of the colorimetric calibrating blocks obtained in Step 304, the calorimetric calibration may be performed to generate the test result. The method of performing colorimetric calibration to generate test results may be summarized as a process 6 as shown in FIG. 6. The process 6 comprises the following steps:

Step 600: Start.

Step 602: Perform edge detection.

Step 604: Determine whether the C-line is detected. If yes, go to Step 606; otherwise, go to Step 608.

Step 606: Determine whether the T-line is detected. If yes, got to Step 610; otherwise, go to Step 612.

Step 608: Determine the test result as “invalid”.

Step 610: Determine the test result as “positive”, and continue to Step 614.

Step 612: Determine the test result as “negative”.

Step 614: Calculate the grayscale value of the T-line and perform interpolation comparison between the grayscale value of the T-line and the grayscale value of the colorimetric calibrating blocks so as to obtain the reference concentration of the specimen.

Step 616: End.

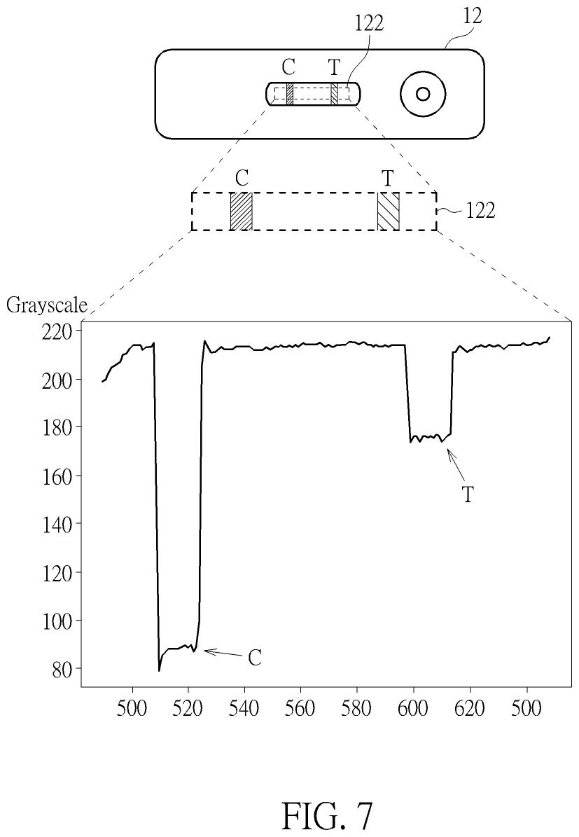

In detail, please refer to FIG. 7 for the detailed operation of the process 6. FIG. 7 is a schematic diagram of edge detection performed in Step 602 to detect the C-line and the T-line. First, an ROI 122 including the color blocks 120 is obtained, and edge detection is performed on the ROI 122 to detect the C-line (marked by C in FIG. 7) and the T-line (marked by T). Next, it is first determined whether the C-line is detected in Step 604. If yes, Step 606 is executed to continue to determine the test result; otherwise, the test result of the test strip 12 is invalid, and the result is displayed through the output unit (Step 608). In Step 606, after the C-line is detected, the further determination of whether there is a T-line is taken. If yes, the test result is determined to be “positive”, and Step 614 is executed to perform quantitative analysis of the concentration of the specimen; otherwise, the test result is determined to be “negative” and displayed through the output unit (Step 612). In step 614, the grayscale value of the T-line is calculated through full width at half maximum (FWHM) algorithm, and then interpolation comparison with the grayscale values of the colorimetric calibrating blocks A1-A4 is performed to estimate the relative concentration of the specimen. Taking the specimen as a virus as an example, when the virus content is higher (high concentration), the color of the T-line is darker; when the virus content is lower, the color of the T-line is lighter. Accordingly, the reference concentration of the specimen may be determined through the color depth of the T-line.

Note that, in the above embodiments, the test strip for lateral fluid immunochromatography assays is used as an example; however, it is not limited thereto. In addition, the above embodiments use two positioning markers and four kinds of colorimetric calibrating blocks as examples, and are not limited thereto. For example, the test strip 12 may be a test strip with multiple specimens, such as a urine test strip for ten items. The urine test strip may measure glucose, protein, leukocyte esterase, urobilinogen, PH, density, occult blood, ketone bodies, nitrite and leukocytes in urine at the same time, and different specimens correspond to different color blocks 120. Those skilled in the art may design the corresponding color and quantity for colorimetric calibrating blocks according to the requirements of color blocks reacted with the specimen, and may also use positioning markers with different resolutions or different numbers according to the required quantity for colorimetric calibrating blocks. Through the technology of embedding the colorimetric calibrating blocks in the positioning marker, additional detection and positioning of the colorimetric calibrating blocks is not required, thereby shortening the time spent for obtaining the test result.

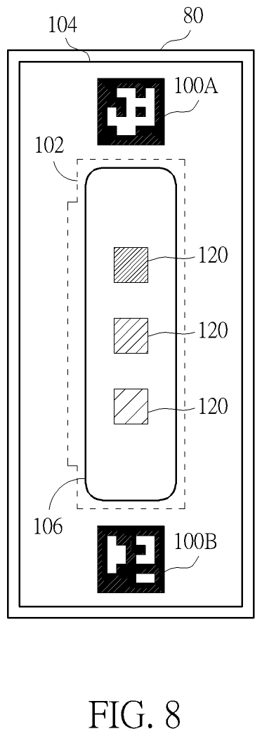

In addition, the test strip detecting system 1 is an embodiment of the present invention, and those skilled in the art may make various modifications accordingly, but are not limited to this. For example, please refer to FIG. 8, which is a schematic diagram of a test strip detecting carrier 80 according to an embodiment of the present invention. The test strip detecting carrier 80 is derived from the test strip detecting carrier 10, which may replace the test strip detecting carrier 10 in the test strip detecting system 1, so the same elements are denoted by the same symbols. Different from the test strip detecting carrier 10, the test strip detecting carrier 80 further comprises a colorimetric board 104 that may cover on the test strip detecting carrier 10. The colorimetric board 104 comprises a window 106, the positioning marker 100A, the positioning marker 100B and the plurality of colorimetric calibrating blocks (not shown in the figure). In other words, compared to the test strip detecting carrier 10 where the positioning markers 100A and 100B are formed on both sides of the container structure 102, in the test strip detecting carrier 80, the positioning markers 100A and 100B are respectively formed on both sides of the window 106 of the colorimetric board 104. For both of the test strip detecting carriers 10 and 80, the plurality of colorimetric calibrating blocks are embedded inside the positioning markers 100A and 100B. In this embodiment, when the colorimetric board 104 is covered on the container structure 102 of the test strip detecting carrier 80, the window 106 is superimposed on the container structure 102 to expose the color block 120. Through the above design, when the user needs to test the test strip 12 through the test strip detecting system 1 (with the test strip detecting carrier 80), the user only needs to place the test strip 12 having the color blocks 120 already reacted with the specimen in the container structure 102 of the test strip detecting carrier 80 and then to cover the test strip 12 that exposes the color blocks 120 on the test strip detecting carrier 80 with the colorimetric board 104. Accordingly, the original image may be captured by the mobile communication device 14 for detection. It should be noted that the implementation of the test strip detecting carriers 10 and 80 adopted in the present invention is not limited thereto, and all the test strip detecting carriers that may simplify the process of locating the colorimetric calibrating blocks through embedding the colorimetric calibrating blocks inside the positioning markers conform to the spirit of the present invention.

In summary, the test strip detecting carrier, the test strip detecting method and the test strip detecting system of the present invention may easily obtain objective test results through a mobile communication device. By embedding the colorimetric calibrating blocks inside the positioning markers, the image positioning, correction and colorimetry may be quickly performed to shorten the time spent for obtaining the test result. Moreover, quantitative analysis of the specimen may be performed to identify the positive concentration of the specimen.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A test strip detecting carrier for a test strip detecting system, comprising:
a container structure, used for containing a test strip;
at least two positioning markers, formed at two sides of the container structure; and
a plurality of colorimetric calibrating blocks, embedded inside the at least two positioning markers;
wherein the test strip reacts with a specimen to generate at least one color block.

2. The test strip detecting carrier of claim 1, further comprising a colorimetric board for covering the test strip detecting carrier, wherein the colorimetric board comprises a window, the plurality of colorimetric calibrating blocks and the at least two positioning markers, wherein when the colorimetric board is covered on the test strip detecting carrier, the window is superimposed on the container structure to expose the at least one color block.

3. The test strip detecting carrier of claim 1, wherein the container structure is rectangular, and the at least two positioning markers are formed on two short side of the container structure.

4. The test strip detecting carrier of claim 1, wherein the at least two positioning markers are ArUco markers.

5. A test strip detecting system, comprising:
a test strip detecting carrier, comprising a container structure, at least two positioning markers and a plurality of colorimetric calibrating blocks, wherein the container structure is used for containing a test strip, the test strip reacts with a specimen to generate at least one color block, the at least two positioning markers are formed at two sides of the container structure, and the plurality of colorimetric calibrating blocks are embedded inside the at least two positioning marker; and
a mobile communication device, comprising:
an image capturing unit;
a processing unit, configured to execute a program code; and
a storage unit, coupled to the processing unit to store the program code, wherein the program code is configured to instruct the processing unit to execute a test strip detecting method, and the test strip detecting method comprises:
controlling the image capturing unit to capture an original image of the test strip placed in the test strip detecting carrier, and to store the original image in the storage unit;
detecting the at least two positioning markers in the original image to obtain a plurality of coordinates of the at least two positioning markers;
performing image coordinate calibration according to the plurality of coordinates to generate a calibrated image; and
performing colorimetric calibration for the color blocks and the plurality of colorimetric calibrating blocks according to the calibrated image so as to generate a test result.

6. The test strip detecting system of claim 5, wherein the at least two positioning markers are ArUco markers.

7. The test strip detecting system of claim 5, wherein the step of detecting the at least two positioning markers in the original image to obtain a plurality of coordinates of the at least two positioning markers comprises obtaining information of the plurality of the colorimetric calibrating blocks.

8. The test strip detecting system of claim 5, wherein the step of performing image coordinate calibration according to the plurality of coordinates to generate a calibrated image comprises executing a perspective transformation.

9. The test strip detecting system of claim 5, wherein the test result comprises a concentration of the specimen.

10. The test strip detecting system of claim 5, further comprising a cloud server, wherein the test strip detecting method further comprises uploading the original image and the test result to the cloud server, and storing in a database of the cloud server.

11. The test strip detecting system of claim 10, wherein the test strip detecting method further comprises generating the test result through cloud computing.

12. A test strip detecting method for a test strip detecting system, wherein a test strip detecting carrier of the test strip detecting system comprises a container structure, at least two positioning markers and a plurality of colorimetric calibrating blocks, wherein the container structure is used for containing a test strip, the test strip reacts with a specimen to generate at least one color block, the at least two positioning markers are formed at two sides of the container structure, the plurality of colorimetric calibrating blocks are embedded inside the at least two positioning marker, and the test strip detecting method comprises:
controlling the image capturing unit to capture an original image of the test strip placed in the test strip detecting carrier, and to store the original image in the storage unit;
detecting the at least two positioning markers in the original image to obtain a plurality of coordinates of the at least two positioning markers;
performing image coordinate calibration according to the plurality of coordinates to generate a calibrated image; and
performing colorimetric calibration for the color blocks and the plurality of colorimetric calibrating blocks according to the calibrated image so as to generate a test result.

13. The test strip detecting method of claim 12, wherein the at least two positioning markers are ArUco markers.

14. The test strip detecting method of claim 12, wherein the step of detecting the at least two positioning markers in the original image to obtain a plurality of coordinates of the at least two positioning markers comprises obtaining information of the plurality of the colorimetric calibrating blocks.

15. The test strip detecting method of claim 12, wherein the step of performing image coordinate calibration according to the plurality of coordinates to generate a calibrated image comprises executing a perspective transformation.

16. The test strip detecting method of claim 12, wherein the test result comprises a concentration of the specimen.

17. The test strip detecting method of claim 12, further comprising uploading the original image and the test result to a cloud server, and storing in a database of the cloud server.

18. The test strip detecting method of claim 17, further comprising generating the test result through cloud computing.
